(19) United States
(12) Patent Application Publication
(10) Pub. No.: US 2009/0159357 A1
(43) Pub. Date: Jun. 25, 2009

(54) Vehicle

(76) Inventor: Rainer Diederich, Reichshof (DE)

Correspondence Address: HUDAK, SHUNK & FARINE, CO., L.P.A., 2020 FRONT STREET, SUITE 307, CUYAHOGA FALLS, OH, 44221, US

(21) Appl. No.: 12/313,524

(22) Filed: Nov. 21, 2008

Related U.S. Application Data
(60) Provisional application No. 61/004,090, filed on Nov. 24, 2007.

(30) Foreign Application Priority Data
Nov. 23, 2007 (DE) 102007056779.2-21

(51) Int. Cl. F02D 11/02; B60Q 1/00

(52) U.S. Cl. 180/335; 362/459

(57) ABSTRACT

At least one further accelerator actuating device in a motor-drivable or motor-driven vehicle comprising a first accelerator actuating device, which can be manually actuated.

### CROSS REFERENCE

This application is based on U.S. Provisional Patent Application 61/004,090, filed Nov. 24, 2007 for a Vehicle, and claims the priority of German Application No. 10 2007 056 779.2-21, filed Nov. 23, 2007.

### FIELD OF THE INVENTION

The invention relates to a motor-drivable or motor-driven vehicle comprising a first accelerator actuating device and/or comprising at least one light-emitting device, an accelerator actuating unit for such a vehicle as well as a circuit configuration for such a vehicle.

### BACKGROUND OF THE INVENTION

Motor-driven or drivable vehicles comprising a first accelerator actuating device are known, such as motorcycles and other motor-driven two-wheelers, as well as quads or ATV (all terrain vehicle), that is, vehicles comprising four wheels, which are embodied as terrain vehicles, snowmobiles and jet skis. For motorcycles and mopeds and motor-driven two-wheelers, respectively, provision is made, for the most part, for at least a twist grip throttle as an accelerator actuating device, whereas a thumb-operated accelerator lever is used for snowmobiles, jet skis, quads and ATVs. Twist grip throttles as well as thumb-operated accelerator levers are typically provided with an accelerator cable. The accelerator cable represents the mechanical connection to the throttle flap or to another element, which is to be actuated by means of the accelerator actuating device.

The accelerator actuating device is typically arranged on the right-hand side of the vehicle, in particular at the handle bar thereof. However, it also became apparent that this can be insufficient in some situations.

### SUMMARY OF THE INVENTION

The instant invention is thus based on the object of developing a motor-drivable or motor-driven vehicle comprising a first accelerator actuating device in such a manner that an accelerator actuation for moving the vehicle and a driving are possible for the driver in virtually any situation.

The object for a vehicle comprising a first accelerator actuating device which can be manually actuated is solved in that provision is made for at least one further accelerator actuating device. For a vehicle comprising at least one light-emitting device, the object is solved in that provision is made for a turn-off device for lightless switching of the at least one light-emitting device while maintaining the function of the device. For an accelerator actuating device for use in a vehicle, the object is solved in that the accelerator actuating unit comprises two accelerator actuating devices, at least two holding devices for fastening the accelerator actuating devices on the vehicle and two accelerator cables, which are capable of being coupled or which are coupled. For a circuit configuration for a vehicle, the object is solved in that the circuit configuration comprises at least one turn-off device for lightless switching of light-emitting components of the circuit. Developments of the invention are defined in the dependent claims.

This creates a motor-drivable or motor-driven vehicle comprising at least two accelerator actuating devices, which has the possibility of using either the one or the other accelerator actuating device. This provides for the most different applications for the vehicle. Persons, who have experienced a limitation on one side during the drive, can thus in particular also operate the respective accelerator actuating device using the other side of the body. The one further accelerator actuating device can in particular be actuated manually so that an actuation is possible either with the right or the left hand of the driver. Furthermore, two accelerator actuating devices are advantageously arranged in the region of a handle bar of the vehicle. Both accelerator actuating devices can thus be operated alternately in a simple manner by means of the right or the left hand of the driver.

In this context, it has proven to be particularly advantageous when the further accelerator actuating device is an accelerator lever or an accelerator switch, in particular a thumb-operated accelerator lever for actuating by means of a thumb of an operator. For those vehicles, which use a thumb-operated accelerator, such as quads, ATVs, jet skis and snowmobiles, for example, the provision of a thumb-operated accelerator lever, which corresponds to a thumb-operated accelerator lever, which is already provided in the area of the handle bar of this vehicle, proves to be very advantageous, because the operator can either actuate the one or the other thumb-operated accelerator lever. This even enables a more or less delay-free change between the two accelerator actuating devices. In the alternative, the further accelerator actuating device can also be a twist grip throttle. Twist grip throttles are actually provided for two-wheelers, such as motorcycles, scooters and mopeds. Fundamentally, such a twist grip throttle can, however, also be provided as a further accelerator actuating device for quads, ATVs, jet skis and snowmobiles as well as for other vehicles, which typically encompass a thumb-operated accelerator. Fundamentally, it would even be possible to provide such a further accelerator actuating device in the form of a twist grip throttle on a two-wheeler, wherein in this case the second handle of the handle bar of the two-wheeler, which actually serves a different function, could be converted so as to perform this new function. The actual function of the second handle bar of a two-wheeler can then be embodied in the form of a lever or a superposed twist grip, for example.

With a motor-drivable or motor-driven vehicle comprising a first accelerator actuating device, which can be manually actuated, it further provides to be advantageous to arrange the accelerator actuating device or the further accelerator actuating device on the left-hand side of the vehicle. Typically, the first accelerator actuating device is arranged on the right-hand side of the vehicle, for the most part in the region of the handle bar of the vehicle. By means of the configuration on the left-hand side of the vehicles, it is possible to enable persons, who are unilaterally disabled or injured or persons who are unilaterally limited during the drive due to picking up an object or due to an unforeseen event, respectively, to actuate the accelerator using the left hand. If the accelerator actuating device were only arranged on the left-hand side of the vehicle, it goes without saying that a simpler actuation would be possible for left-handed persons. In response to the bilateral configuration of the accelerator actuating devices, however, it proves to be particularly advantageous that a change of the actuating side is also possible during the drive, for example when the right hand, as already mentioned, is needed for a different purpose than for the actuation of the accelerator, but when a continuation of the drive is not be hindered.

Advantageously, provision is made for at least a further accelerator cable for the further accelerator actuating device. Preferably, the further accelerator cable is effectively connected to an accelerator cable of the first accelerator actuating device or to the element, which is to be actuated by means of the accelerator cable of the first accelerator actuating device, in particular a throttle flap or it can be effectively connected thereto. It is possible hereby to attain the same effect either by means of the one or by means of the other accelerator actuating device, that is, the adjustment of the throttle flap, for example. A further change-over between the two accelerator actuating devices is thus not necessary, but a change of the actuating from the one accelerator actuating device to the other can take place directly and thus rapidly. On principle, it goes without saying that it would also be possible to provide an additional change-over device, via which a change-over from the first accelerator actuating device to the at least one further one is possible, so that the operator can always use only one of the two accelerator actuating devices. However, such a change-over device then proves to be disadvantageous because the change-over requires too much time when a rapid change between the two accelerator actuating devices is required, as it could be the case with military uses of the vehicle, for example.

For the effective connection of the two accelerator cables, it is advantageous to guide the accelerator cable of the one further accelerator actuating device is preferably guided to the accelerator cable of the first accelerator actuating device and engages with the same actuator, which can be actuated by means of an actuating element, in particular an accelerator lever or accelerator switch of the first accelerator actuating device so that, in response to the actuation of the further accelerator actuating device, the first accelerator cable is in turn actuated and thus an actuation of a throttle flap, e.g., thus takes place. In the alternative, the second accelerator cable as well as the first accelerator cable can be guided up to the element, which is to be actuated by means of the first accelerator cable, e.g., the throttle flap. This element is hereby either engaged by means of the first or the second accelerator cable and said element is actuated. However, the first alternative is simpler with respect to its construction, where the second accelerator cable is guided towards the first accelerator actuating device and on principle indirectly actuates said accelerator actuating device, because it is not necessary to additionally directly or indirectly tie an accelerator cable to the element, e.g., a throttle flap, which is to be actuated by said accelerator cable.

According to a development, provision can be made on the vehicle for at least one jump start device. It is possible hereby to jump-start another party, which can prove to be advantageous in particular in response to drives in areas, which are not highly populated and which are not easily accessible, because otherwise, in case the vehicle of another party does not start, this other party would possibly have to walk all the way to a body shop. By providing such a jump start device, however, it is possible to jump-start the other party in such areas.

Advantageously, the jump start device is arranged on the rear side of the vehicle. This provides for a good accessibility, on the one hand, and, on the other hand, the danger of an unintentional contact with the jump start device does not exist for the driver during the daily use of the vehicle. Even though the positive terminal of the jump start device is preferably provided with a cover, it goes without saying that the safety for the driver, however, is even higher when the possibility of an unintentional contact with the jump start device is even further limited by the suitable positioning thereof on the rear side of the vehicle. As a matter of principle, however, the positioning on another location of the vehicle is possible, wherein the protection of the driver against an unintentional contact with said jump start device should be considered when choosing the positioning thereof.

If the driver of the vehicle uses a night vision device, it proves to be extremely advantageous to provide a turn-off device for a lightless switching of the at least one light-emitting device of the vehicle, while maintaining the function of the device. In particular when using a night vision device, the problem that the driver of the vehicle is highly blinded and that his view is thus impeded arises routinely due to the light-emitting devices on the vehicle, which comprise all types of light sources. Such light-emitting devices can be signal lights, headlights, diverse display devices and other light sources on the vehicle, such as indicator lights and other functional lights. They are temporarily switched in a lightless manner by means of the turn-off device, in particular while being separated from the power supply, but they are not completely turned off. They then no longer emit light when the driver of the vehicle does not want this. However, when the driver wants to allow for the emission of light again, he can obtain this state again, in particular by re-actuating the turn-off device or a turn-on device.

For actuating the turn-off device, it advantageously encompasses at least one actuating switch, which can be operated by the driver so that the driver can subsequently see without being blinded, in particular by means of a night vision device and so that the driver can, at the same time, drive the vehicle.

For a lightless switching of the at least one light-emitting device, the turn-off device is advantageously effectively connected to a switching device, in particular a relay, which can separate the light-emitting devices, which are connected thereto, from the power supply. Advantageously, the actuating switch can open the switching device, wherein the switching device is connected to the light-emitting devices. By accessing the at least one switching device, the emission of light can be interrupted temporarily. In particular, a relay is opened as a switching device by actuating the turn-off device so that power is no longer supplied to the light-emitting device, which is connected to the relay. Advantageously, the turn-off device comprises a change-over relay, which is connected to at least one light-emitting device and an infrared headlight and which can be changed over therebetween. The change-over relay or generally the change-over device can be actuated by a further relay as a switching device or by the turn-off device itself, wherein said change-over relay switches from further light-emitting devices to advantageously one infrared headlight. Such an infrared headlight typically does not have a negative impact, but rather a positive impact with reference to a night vision device. Switching back and forth between light-emitting devices for the daylight vehicle operation and at least one infrared headlight for a night-time vehicle operation with a night vision device thereby proves to be highly advantageous.

Central access to all light-emitting devices is possible via the turn-off device so that all of them can be switched in a lightless manner. If a light-emission is to be permitted again subsequently, it is possible, on the one hand, to make this possible by means of re-actuating the turn-off device, by means of a restarting device or by means of turning on the individual light-emitting devices again.

### BRIEF DESCRIPTION OF THE DRAWINGS

For the purpose of defining the invention in more detail, exemplary embodiments of the invention will be described below in more detail by means of the drawings:

FIG. 1 shows a perspective view of a vehicle in the form of a quad comprising two accelerator actuating devices according to the invention,

FIG. 2 shows a perspective view of the detail of the handle bar of the vehicle according to FIG. 1,

FIG. 3 shows a top view onto an embodiment of a function of the accelerator cables of the two accelerator actuating devices according to FIGS. 1 and 2,

FIG. 4 shows a circuit configuration for a turn-off device for lightless switching of the light-emitting devices of the vehicle according to FIG. 1 and

FIG. 5 shows the circuit configuration according to FIG. 4, supplemented by a jump start device.

### DETAILED DESCRIPTION OF THE INVENTION

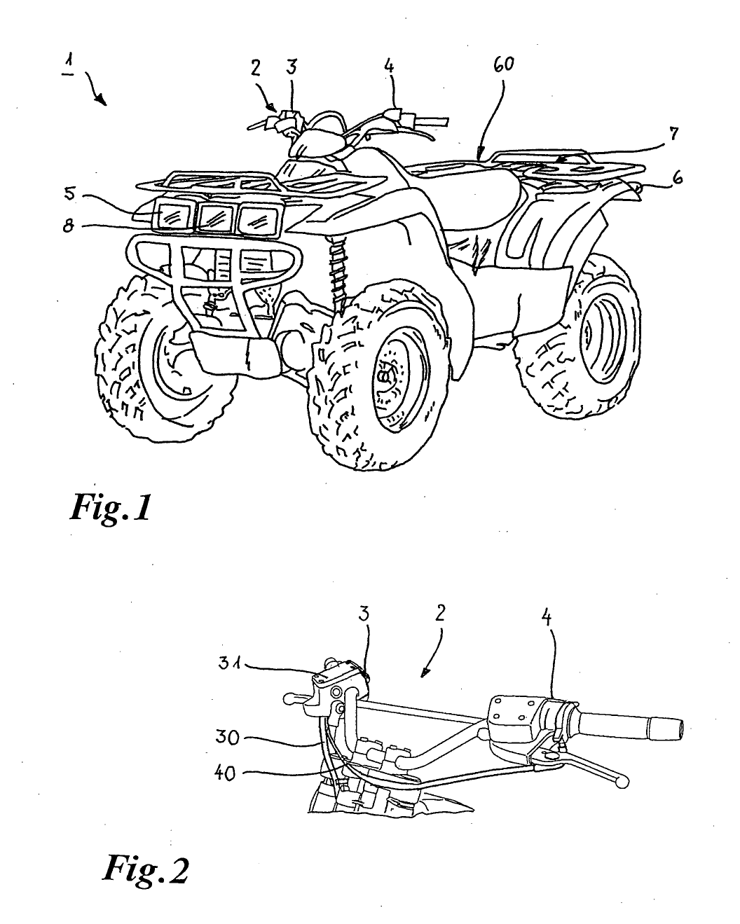

FIG. 1 shows a perspective view of a vehicle 1 in the form of a quad or ATV comprising a handle bar 2 comprising two accelerator actuating devices 3, 4. The two accelerator actuating devices 3, 4 are in each case arranged to the left and to the right of the handle bar. Both accelerator actuating devices 3, 4 are embodied as thumb-operated accelerator, thus as an accelerator lever, which can be operated by the thumb of a person. In the alternative, provision can also be made for another embodiment, for example in the form of a twist grip throttle. However, a thumb-operated accelerator is mostly used for quads and ATVs.

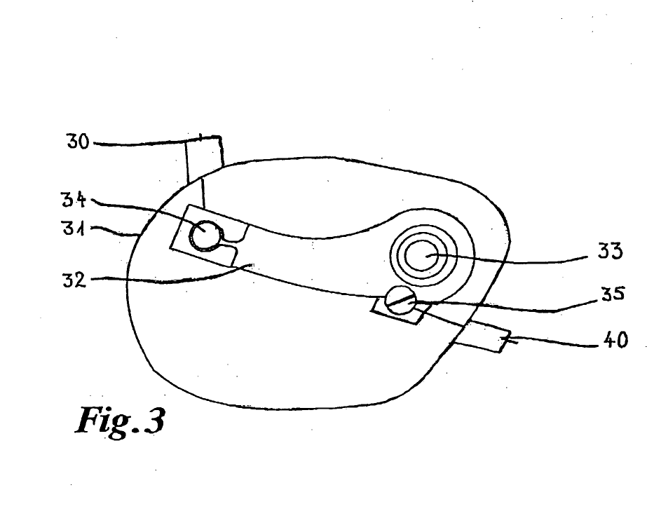

The vehicle 1 further encompasses two front headlights 5, signal lights 6 on both sides, a taillight 7, which is only suggested in FIG. 1, as well as an infrared headlight 8 on the front. The two accelerator actuating devices 3, 4 in each case encompass an accelerator cable 30, 40. This can better be seen in the detailed view in FIG. 2.

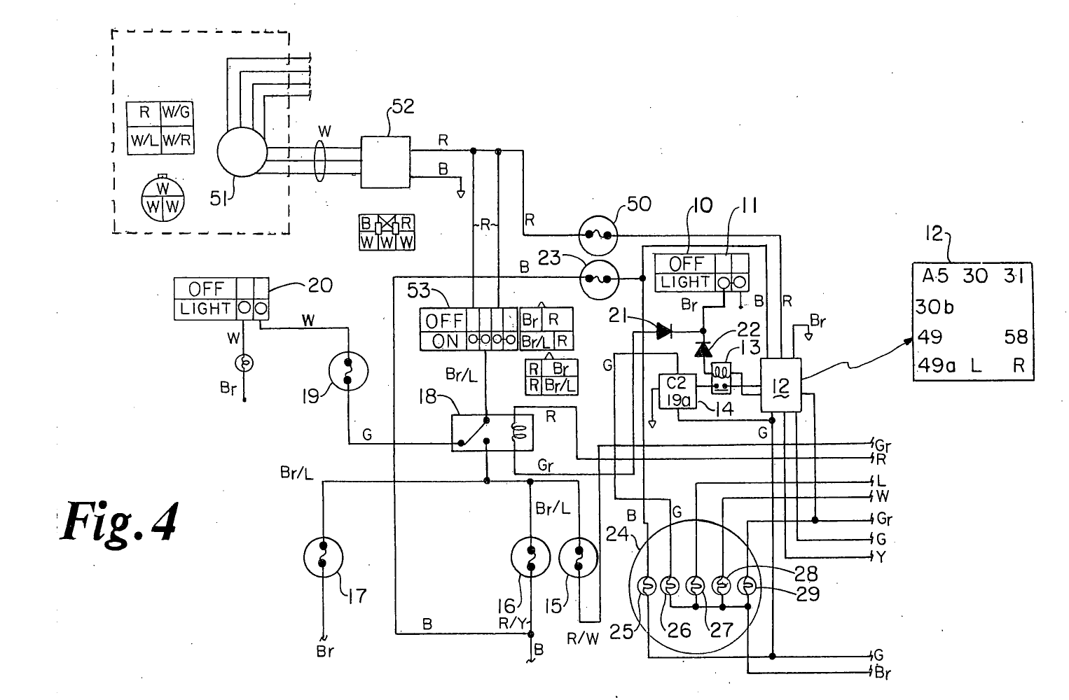

It can be seen from this figure that the accelerator cable 40 of the accelerator actuating device 4, which is arranged on the left-hand side of the handle bar 2, is guided towards the accelerator cable 30 of the accelerator actuating device 3, which is arranged on the right-hand side of the handle bar. Both accelerator cables 30, 40 are guided into a housing 31, which is also arranged on the right-hand side of the handle bar 2. A detailed view of the housing 31 as well as of the further elements arranged therein can be inferred from the detailed view in FIG. 3.

A lever 32, which is connected to the accelerator actuating device 3 via an axle 33, is arranged in the housing 31. The axle 33 is supported in the housing and is connected to the lever 32 and on the accelerator actuating device in the form of a thumb-operated accelerator lever. In response to the actuation of the accelerator actuating device 3, the lever 32 is thus pivoted about the axle 33. The two accelerator cables 30, 40 are connected to the lever 32 via a respective connecting point 34, 35. The end of the accelerator cable 30 is connected to the lever 32 in the connecting point 34, whereas the accelerator cable 40 is fastened closer to the axle 33 in the connecting point 35.

In response to the actuation of the accelerator actuating device 3, which is arranged on the right-hand side of the handle bar 2, the lever 32 is pivoted and an actuation of the element, for example a throttle flap, which is connected to the accelerator cable and which is to be actuated by means of the accelerator actuating device 3, thus becomes possible by engaging with the accelerator cable 30. By also connecting the accelerator cable 40 to the lever 32, it is possible to also engage with this lever 32 in response to the actuation of the accelerator actuating device 4 via the accelerator cable 40 and to thus effect an actuation of the accelerator cable 30, which, in turn, actuates a throttle flap, for example. It is thus possible to access the accelerator cable 30 by actuating the accelerator actuating device 3 as well as the accelerator actuating device 4 and to thus actuate a throttle flap, for example, or another actuating element of a carburetor.

As an alternative to the connection of the accelerator cable 40 to the accelerator cable 30, it is possible to guide both accelerator cables parallel to one another to the element, which is to be actuated, for example a throttle flap, and, in the alternative, to permit an actuation by means of the accelerator cable 30 or the accelerator cable 40. However, this embodiment is not illustrated in FIGS. 2 and 3.

If a twist grip throttle is used instead of a thumb-operated accelerator, provision can be made for a corresponding embodiment of the effective connection of accelerator cable 30 and accelerator cable 40, wherein either the one accelerator cable is guided to the other accelerator cable in such a manner that an actuation of the element, which is to be actuated by means of the accelerator cable, for example a throttle flap, takes place directly or indirectly by means of the one accelerator cable or that both accelerator cables are guided parallel to the throttle flap or another actuating element of the carburetor.

FIG. 4 shows a portion of a circuit configuration of vehicle 1 according to FIG. 1. The circuit configuration represents the detail of a turn-off device 10 for lightless switching of at least one light-emitting device. The turn-off device 10 comprises an actuating switch 11, which is connected to two relays. The first relay 13 is connected between a hazard switch 12 and a flashing relay 14. The second relay 18 is connected via a diode 21 between the switch 11 and three fuses 15, 16, 17, which comprise a fuse 15 for the instruments of the vehicle, a fuse 16 for the illumination as well as a fuse 17 for a brake light. Switches, which are not illustrated in FIG. 4 and by means of which the vehicle light, for example, can be turned on, are connected to these fuses.

An infrared headlight switch 20 as well as a fuse 19 for it is further illustrated in FIG. 4. They are also connected to the relay 18, wherein the relay 18 is a change-over relay, which can switch back and forth between the afore-mentioned devices and the infrared headlight.

Provision is also made for a diode 22 between the actuating switch 11 and the relay 13. Furthermore, a turn signal control 26, which is part of an indicator light unit 24, is connected to the flashing relay 14. The indicator light unit 24 comprises further indicator lights, namely a turn signal control 25, the already mentioned turn signal control 26 for a trailer for the vehicle 1, a rear fog light control 27, a high beam control 28 as well as a parking light control 29. Typically, all of these indicator lights are arranged in the cockpit of the vehicle 1 so as to be capable of being registered by the driver during the drive.

The hazard switch 12 is furthermore also connected via a fuse 23 behind the fuse 16 for the illumination. This branch leads to a handle bar switch and to a light switch, respectively, which is not illustrated in FIG. 4. Furthermore, the hazard switch 12 is also connected via a fuse 50 to a generator 51 via a controller 52. An ignition switch 53, which is also guided to the relay 18, is also connected to the generator 51 via the controller 52.

In rest position, the actuating switch 11 is closed. Accordingly, the relay coil of the relay 13 is grounded so that the operating contact of the relay is tightened. The turn signals of the vehicle can thus emit a flashing light when an actuation of the turn signal switch or of the hazard switch 12 takes place. The relay coil of the relay 18 is hereby also grounded so that the change-over switch in this relay enables a power supply of all of the light-emitting devices of the vehicle via the line, which is connected to the relay, thus via the line branches, in which the fuses 15, 16, 17 are arranged.

If the actuating switch 11 is now actuated, thus brought from the rest position into an open position, the relay 13 opens so that a current connection is no longer available for the turn signals. Accordingly, the relay 18 also opens so that the change-over switch switches all of the light-emitting devices currentless, because it changes to the current connection for the infrared headlight 8. The infrared headlight cannot be turned on in this position, whereas all of the other light-emitting devices are switched currentless, thus can no longer emit any light. This also applies for the indicator light unit 24 so that the indicator lights are also dark.

This switch setting of the actuating switch 11 makes it possible for the driver, who is driving with a night vision device, to no longer be blinded by the light-emitting devices of the vehicle, in particular also by the indicator lights. To prevent that a current flows unintentionally via the relay 13 and the relay 18 in the actually turned-off state, provision is made for the two diodes 21, 22, which are mutually connected.

As a matter of principle, another embodiment could also be chosen here, where a two-pole switch, for example, individually actuates each relay winding of the two relays 13, 18. Every other device, which fulfills the same function, can also be used here so as to reliably prevent that a light emission takes place again unintentionally by means of the light-emitting devices and suddenly blinds the driver, who wears a night vision device, during the drive.

As an alternative to the illustrated embodiment of a turn-off device 10 comprising two relays 13, 18 and two diodes 21, 22, a single switch, which is designed as a change-over switch, could also be used or a semiconductor power switch (electronic relay) which enables a change-over between the light-emitting devices and the infrared headlight. As soon as a change-over to the infrared headlight takes place, the other users and light-emitting devices, respectively, are switched currentless. However, when using such a change-over switch, cables would have to be laid to the switch by all of the light-emitting devices., also the indicator light 24. To avoid this, the embodiment illustrated in FIG. 4 comprising the two relays 13, 18 can be chosen advantageously.

After the lightless switching of the light-emitting devices, the actuation of the actuating switch 11 can again attain the rest position thereof, thus the closed switch position, wherein all of the light-emitting devices are again connected to the power supply. Only the infrared headlight is switched currentless so that the actuation thereof is then no longer possible. An unintentional discharging of the battery, for example, can be avoided hereby because the infrared light cannot be detected by the human eye and because there is no indicator light for the infrared headlight. After switching the actuating switch 11 back into the rest position, thus the closing of the switch, all of the light-emitting devices can directly be switched back again into the state, which had been assumed prior to the actuation of the actuating switch 11. They can thus be turned on before light-emitting devices or before it becomes necessary to turn on these devices again.

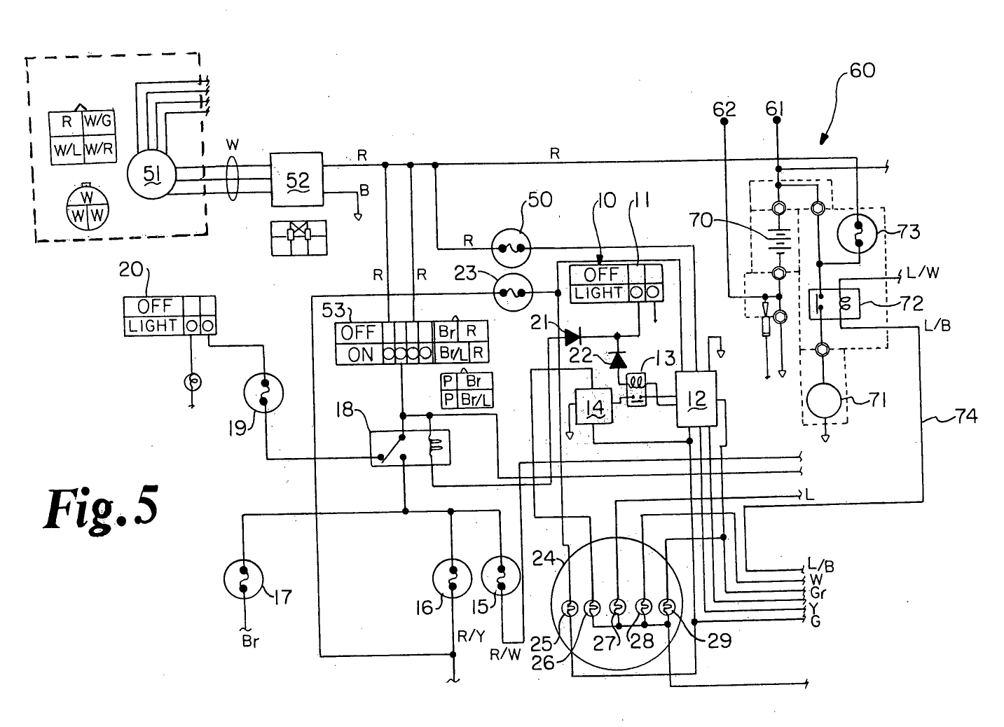

FIG. 5 shows the circuit configuration according to FIG. 4, supplemented by a jump start device 60. Said jump start device is connected directly to a battery 71 of the vehicle, wherein positive terminal and negative terminal at the connecting points 61 and 62 are directly guided outside to the exterior of the vehicle. The connecting point 61 of the positive terminal is protected at that location by means of a cover cap. The connecting point of the negative terminal can be provided in the form of a pin or in a different form on the exterior of the vehicle without protection. As can be seen from FIG. 1, the jump start device 60 is arranged on the rear side of the vehicle.

In addition to the battery 70, a starter 71, a starter relay 72 and a main fuse 73 of the vehicle are shown in the circuit configuration in FIG. 5. A line 74 leads from the starter relay to a non-illustrated start pushbutton.

In addition to the embodiments of vehicles comprising accelerator actuating devices and light-emitting devices, which are described above and which are illustrated in the figures, numerous further embodiments can be formed, where provision is made in each case for at least two accelerator actuating devices and/or for a turn-off device for lightless switching of the light-emitting devices. In addition to the use of the two accelerator actuating devices for a quad or ATV, such accelerator actuating devices can also be used for snowmobiles, jet skis or also for motor-driven two-wheelers. A twist grip throttle is mostly provided for the latter group, wherein it is possible without problems, however, to provide two accelerator actuating devices or, if necessary, even more than two accelerator actuating devices in parallel. Such accelerator actuating devices can thus be provided for all vehicles, which at least enable manual access thereto. The turn-off device for lightless switching of light-emitting devices of the vehicle can also not only be provided for quads, ATVs, snowmobiles, jet skis and two-wheelers, but on principal also for all other vehicles, where this can prove to the advantageous. It goes without saying that the accelerator actuating devices and the turn-off device are provided on a vehicle individually or in combination with one another. Furthermore, the provision of a jump start device is also possible for all of these vehicles without problems.

### List of Reference Numerals

1 vehicle

2 handle bar

3 accelerator actuating device

4 accelerator actuating device

5 front headlight

6 turn signal

7 taillight

8 infrared headlight

10 turn-off device

11 actuating switch

12 hazard switch

13 relays turn signal off

14 flashing relay

15 fuse instruments

16 fuse illumination

17 fuse brake light

18 relay light instruments off

19 fuse infrared headlight

20 switch infrared headlight

21 diode

22 diode

23 fuse turn signal

24 indicator light unit

25 turn signal control

26 turn signal control trailer

27 rear fog light control

28 high beam control

29 parking light control

30 accelerator cable

31 housing

32 lever

33 axle

34 connecting point of 30

35 connecting point of 40

40 accelerator cable

50 fuse

51 generator

52 controller

53 ignition switch

60 jump start device

61 connecting point positive terminal

62 connecting point negative terminal

70 battery

71 starter

72 starter relay

73 main fuse

74 line

What is claimed is:

1. A motor-drivable or motor-driven vehicle comprising: a first accelerator actuating device, which can be manually actuated, and at least one further accelerator actuating device.

2. The vehicle according to claim 1, wherein the accelerator actuating device can be manually actuated.

3. The vehicle according to claim 1, wherein the at least two accelerator actuating devices are arranged in the region of a handle bar of the vehicle.

4. The vehicle according to claim 3, wherein the further accelerator actuating device is an accelerator lever or an accelerator switch.

5. The vehicle according to claim 4, wherein the accelerator lever is a thumb-operated accelerator lever for actuation by means of a thumb of an operator.

6. The vehicle according to claim 3, wherein the further accelerator actuating device is a twist grip throttle.

7. The vehicle according to claim 1, wherein the accelerator actuating device or the further accelerator actuating device is arranged on the left-hand side of the vehicle.

8. The vehicle according to claim 1, wherein provision is made for at least one further accelerator cable for the further accelerator actuating device.

9. The vehicle according to claim 8, wherein the further accelerator cable can be effectively connected or is effectively connected to an accelerator cable of the first accelerator actuating device or to a throttle flap, which is to be actuated by means of the accelerator cable of the first accelerator actuating device.

10. The vehicle according to claim 9, wherein the accelerator cable of the one further accelerator actuating device is guided to the accelerator cable of the first accelerator actuating device and engages with the same actuator, which can be actuated by an accelerator lever or accelerator switch of the first accelerator actuating device.

11. The vehicle according to claim 1, comprising at least one light-emitting device, and further including a turn-off device for lightless switching of the at least one light-emitting device response to maintaining function of the at least one light-emitting device.

12. The vehicle according to claim 11, wherein the turn-off device comprises at least one actuating switch.

13. The vehicle according to claim 11, wherein the turn-off device is effectively connected to at least one switching device, a relay, for the purpose of separating the light-emitting device, which is connected thereto, from a power supply.

14. The vehicle according to claim 11, wherein the turn-off device comprises a switching relay, which is connected to at least one light-emitting device and an infrared headlight and that it can be switched between them.

15. The vehicle according to claim 1, wherein the vehicle is a quad or an ATV.

16. The vehicle according to claim 1, wherein the vehicle is a snowmobile.

17. The vehicle according to claim 1, wherein the vehicle is a jet ski.

18. The vehicle according to claim 1, wherein the vehicle is a two-wheeler, in particular a motorcycle.

19. The vehicle according to claim 1, further including at least one jump start device.

20. The vehicle according to claim 19, wherein the jump start device is arranged on the rear side of the vehicle.

21. An accelerator actuating unit for use in a vehicle, comprising: two accelerator actuating devices, at least two holding devices for fastening the accelerator actuating devices on the vehicle and two accelerator cables, which are capable of being coupled or which are coupled.

22. The accelerator actuating unit according to claim 21, wherein both accelerator cables engage with the same actuator, which can be actuated by an accelerator lever or accelerator switch of the first accelerator actuating device, wherein the accelerator cable of the second accelerator actuating device is guided to the accelerator cable of the first accelerator actuating device.

23. A circuit configuration for a vehicle according to claim 11, wherein the circuit configuration comprises at least one turn-off device for lightless switching light-emitting components of the circuit configuration.

24. The circuit configuration according to claim 23, wherein the turn-off device comprises at. least one actuating switch and two switching devices, which are connected to the light-emitting components, which can be opened by actuating the actuating switch.

25. The circuit configuration according to claim 23, wherein the turn-off device comprises at least one change-over device for switching between the light-emitting components and an infrared headlight.

26. The circuit configuration according to one of claim 23, wherein the circuit configuration comprises at least one jump start device.
